(19) United States
(12) Patent Application Publication
(10) Pub. No.: US 2010/0252640 A1
(43) Pub. Date: Oct. 7, 2010

(54) THERMOSTATIC MIXING VALVE

(75) Inventor: Zoltan Goncze, Sandown, NH (US)

Correspondence Address: EDWARDS ANGELL PALMER & DODGE LLP, P.O. BOX 55874, BOSTON, MA, 02205, US

(73) Assignee: Watts Water Technologies, Inc., North Andover, MA (US)

(21) Appl. No.: 12/817,794

(22) Filed: Jun. 17, 2010

Related U.S. Application Data
(63) Continuation of application No. 11/357,149, filed on Feb. 17, 2006, now abandoned.

(51) Int. Cl. G05D 23/185; F16K 17/04; F16K 15/08

(52) U.S. Cl. 236/12.11; 137/538

(57) ABSTRACT

A thermostatic mixing valve (TMV) including a low-flow passageway and a high-flow passageway connecting a mixing chamber and a sensing chamber, and a check valve received in the high-flow passageway adapted to open and allow additional flow from the mixing chamber to the sensing chamber upon fluid flow through the valve rising to at least a predetermined high flow rate. The TMV accommodates a wide range of flows yet does not allow excess flow to bypass the sensing chamber which contains a thermal motor of the valve. Even at high flow rates, therefore, the TMV accurately mixes fluid.

### TECHNICAL FIELD OF THE DISCLOSURE

The present disclosure generally relates to fluid control valves and, more particularly, to thermostatic mixing valves. Even more particularly, the present disclosure relates to a thermostatic mixing valve that is adapted to accommodate a wide range of flows yet does not allow excess flow to bypass a sensing chamber surrounding a thermostat element of the valve.

### BACKGROUND OF THE DISCLOSURE

Thermostatic mixing valves (TMVs) are well established and serve to provide a fluid (e.g., water) supply at a desired temperature. TMVs, also referred to as temperature-activated mixing valves, have a temperature responsive thermostat element, or thermal motor, operatively coupled to a valve member controlling fluid flows through hot and cold inlet ports of the valve. The mixed fluids are caused to impinge upon the thermal motor, which in turn expands and contracts and controls the relative proportions of hot and cold fluids passing through the valve. Consequently, when there is an undesirable rise in the temperature of the mixed fluid the thermal motor expands to cause the valve member to reduce the hot flow via the hot inlet port and increase the cold flow via the cold inlet port. Expansion of the thermal motor, therefore, restores the fluid supply temperature condition to that desired, with a converse operation when there is contraction of the thermal motor due to a fall in the mixed fluid temperature.

Large bore TMVs for hot water distribution systems are used to supply hot water for multiple outlets or faucets, such as groups of showers, washbasins, or baths. Large bore TMVs, which are also referred to as master mixing valves, are different than smaller, point-of-use TMVs, in that the large bore TMVs must be capable of passing substantial amounts of properly mixed water when a number of outlets are being used simultaneously. The internal arrangement of the large bore TMV, therefore, is designed such that the high flow rate can be passed without an unduly high-pressure drop. Thus, as its name implies, a large bore TMV is provided with relatively large internal passages to avoid causing any restriction to the mixed water flow under the maximum demand.

There are, however, drawbacks with large bore TMVs, such as achieving sufficient mixing of hot and cold water across a range of flow rates. When there is a low demand for mixed water the velocity of the hot and cold-water streams passing through the large bore TMV drops and is insufficient to mix the two streams fully. The result is that the streams may become laminar and mixing of the hot and cold supplies does not take place. If this happens, then the water surrounding the thermal motor is not fully mixed and as a result the thermal motor may receive a false signal.

One known approach for supplying multiple outlets is to provide a small bore TMV in parallel with a large bore TMV in combination with a pressure reducing valve or some other throttling device on the outlet of the large bore TMV. Thus, when there is a low demand for mixed water the hot and cold streams only pass through the small bore TMV. This approach, however, requires extra hardware in the form of two TMVs and a throttling device and, is therefore, more expensive and requires additional installation steps and maintenance. In addition, temperature regulation is more complicated due to its dependence on the function of two individual TMV thermal motor characteristics.

U.S. Pat. No. 6,604,687 provides another approach and discloses a high flow rate TMV that provides more accurate control of the valve outlet temperature in a low flow rate environment. The valve utilizes a flow-directing element that restricts the flow of water through the valve at low pressures and directs the flow of water toward the thermal motor, such that low flow rates are accommodated. The flow-directing element encircles the thermal motor and is formed from a flexible material so that it expands under pressure of water flowing through the valve, such that high flow rates are accommodated. At no time, however, is excess flow directed so that that it bypasses a “sensing chamber” surrounding the thermal motor.

U.S. Pat. No. 6,820,816, in contrast, provides a TMV for operation across a range of flow rates, wherein excess flow is directed so that that it does bypasses the sensing chamber surrounding the thermal motor. During low flow rate, or normal, operation, check valves in the TMV remain closed so the only pathway mixed water can follow is through the sensing chamber to a discharge portion and out the mixed water outlet. During high flow rate operation the check valves open and allow the mixed water to bypass the sensing chamber and flow directly to the discharge portion and out through the mixed water outlet.

What is still desired is a new and improved thermostatic mixing valve. Preferably the thermostatic mixing valve will be adapted to accommodate a wide range of flows yet will not allow excess flow due to a high-flow rate to bypass a sensing chamber surrounding a thermal motor of the valve.

### SUMMARY OF THE DISCLOSURE

The present disclosure provides a new and improved thermostatic mixing valve (TMV) adapted to accommodate a wide range of flows. According to one exemplary embodiment, the TMV includes a housing having first and second inlets and an outlet. First and second spaced-apart seats are received in the housing and define a mixing chamber between the first and the second inlets. The second seat separates the mixing chamber from a sensing chamber of the housing and includes a low-flow passageway and a high-flow passageway connecting the mixing chamber and the sensing chamber. The sensing chamber is separate from and connected to the outlet of the housing via outlet ports.

The TMV also includes a plunger movably received between the first and the second seats. The plunger and the first seat define a first valve opening controlling flow from the first inlet to the mixing chamber, and the plunger and the second seat define a second valve opening controlling flow from the second inlet to the mixing chamber. A thermal motor is located within the sensing chamber such that expansion of the thermal motor causes movement of the plunger towards the first seat, such that the first valve opening is closed and the second valve opening is opened.

The TMV also includes a check valve received in the high-flow passageway of the second seat. The check valve is adapted to open and allow additional flow from the mixing chamber to the sensing chamber upon fluid flow through the TMV rising to at least a predetermined high flow rate. The additional flow does not bypass the sensing chamber.

Among other aspects and advantages, the new and improved TMV of the present disclosure accommodates high-flow conditions as well as low-flow conditions. Yet the TMV of the present disclosure does not allow excess flow to bypass the sensing chamber containing the thermal motor. Even at high flow rates, therefore, the TMV accurately mixes fluid.

According to one aspect, the TMV further includes a cylindrical cartridge received within the housing. The first and the second seats, the plunger, and the thermal motor are coaxially mounted within the cartridge, and the mixing chamber and the sensing chamber are contained within and partially defined by the cartridge. The cartridge defines the outlet ports connecting the sensing chamber to the outlets of the housing, and further defines first inlet ports connecting the first inlet of the housing to the first valve opening and second inlet ports connecting the second inlet of the housing to the second valve opening. The cartridge allows easier assembly and disassembly of the TMV. In addition, the cartridge prevents the movable plunger from contacting the housing, and allows the more expensive housing to last longer while the less expensive plunger and valve seats are easily disassembled and replaced when worn.

According to an additional aspect, the housing of the TMV includes an upper portion defining the outlet secured to a lower portion defining the first and the second inlets, and the upper portion can be rotated about an axis of the housing with respect to the lower portion. This rotation feature is very helpful during installation of the TMV and allows the outlet to be oriented between 0° and 360° with respect to the inlets.

Additional aspects and advantages of the present disclosure will become readily apparent to those skilled in this art from the following detailed description, wherein only an exemplary embodiment of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF DRAWINGS

Reference is made to the attached drawings, wherein elements having the same reference character designations represent like elements throughout, and wherein:

FIG. 1 is a top perspective view of an exemplary embodiment of a thermostatic mixing valve (TMV) constructed in accordance with the present disclosure;

FIG. 2 is a side elevation view of the TMV of FIG. 1;

FIG. 3 is a side elevation view of the TMV of FIG. 1 shown rotated 90° from the position shown in FIG. 2;

FIG. 4 is a top plan view of the TMV of FIG. 1;

FIG. 5 is an enlarged sectional view of the TMV of FIG. 1 taken along line 5-5 of FIG. 4;

FIG. 6 is an enlarged sectional view, in perspective, of the TMV of FIG. 1 taken along line 5-5 of FIG. 4;

FIG. 7A is a further enlarged sectional view of the TMV of FIG. 1 contained within circle 7 of FIG. 5, wherein low-flow conditions are illustrated;

FIG. 7B is a further enlarged sectional view of the TMV of FIG. 1 contained within circle 7 of FIG. 5, wherein high-flow conditions are illustrated;

FIG. 8 is an exploded side elevation view of the TMV of FIG. 1 shown rotated 180° from the position shown in FIG. 2;

FIG. 9 is an exploded sectional view of the TMV of FIG. 1 taken along line 5-5 of FIG. 4; and

FIG. 10 is an exploded top perspective view of the TMV of FIG. 1.

### DETAILED DESCRIPTION OF EXEMPLARY EMBODIMENTS

Referring to the figures, an exemplary embodiment of a new and improved thermostatic mixing valve (TMV) 10 according to the present disclosure is shown. Among other benefits, the new and improved TMV 10 of the present disclosure accommodates high-flow conditions as well as low-flow conditions. Yet the TMV 10 of the present disclosure does not allow excess flow to bypass a sensing chamber 12 containing a thermostat element 14 of the valve. Even at high flow rates, therefore, the TMV 10 accurately mixes hot and cold fluid.

The new and improved TMV 10 also includes a cartridge 68 that simplifies assembly of the TMV and the replacement of parts within the TMV. In addition, the new and improved TMV 10 includes a housing 16 having an upper portion 80 secured to a lower portion 82 by the cartridge 68. The upper portion 80 of the housing 16 can be rotated with respect to the lower portion 82 in order to allow an outlet 18 of the upper portion to be oriented between 0° and 360° with respect to inlets 18, 20 of the lower portion 82 during installation of the TMV 10. The rotation feature is provided to ease connecting conduits to the TMV 10 during installation of the TMV (e.g., an inlet pipe connected to the TMV does not have to be aligned with an outlet pipe connected to the TMV).

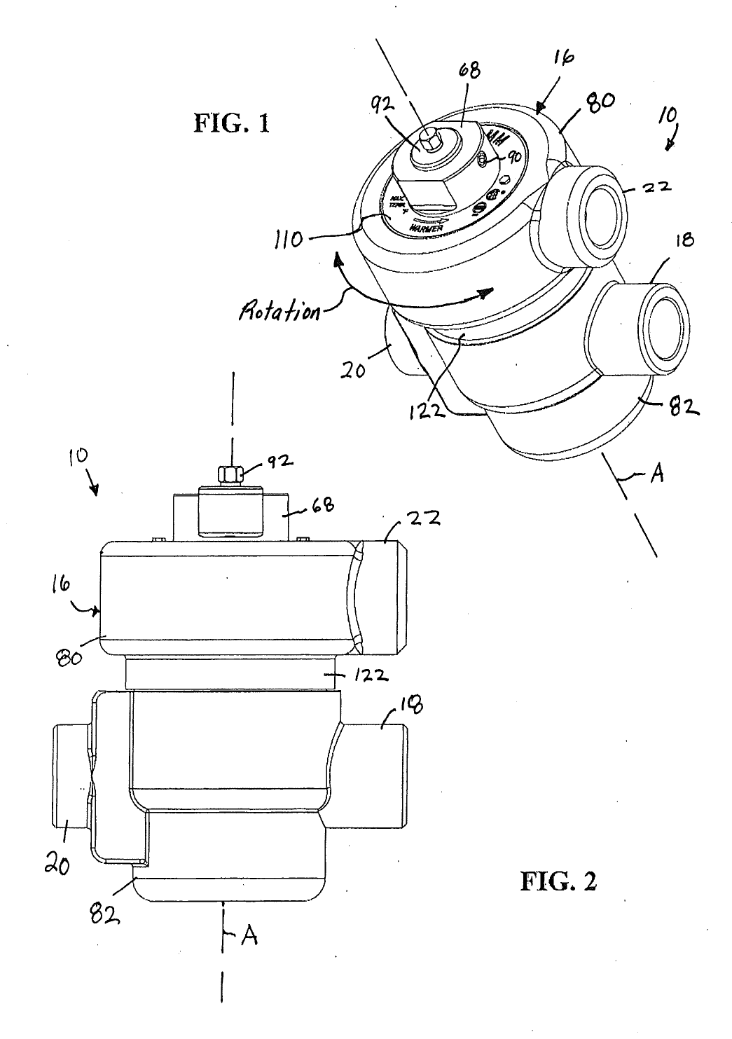

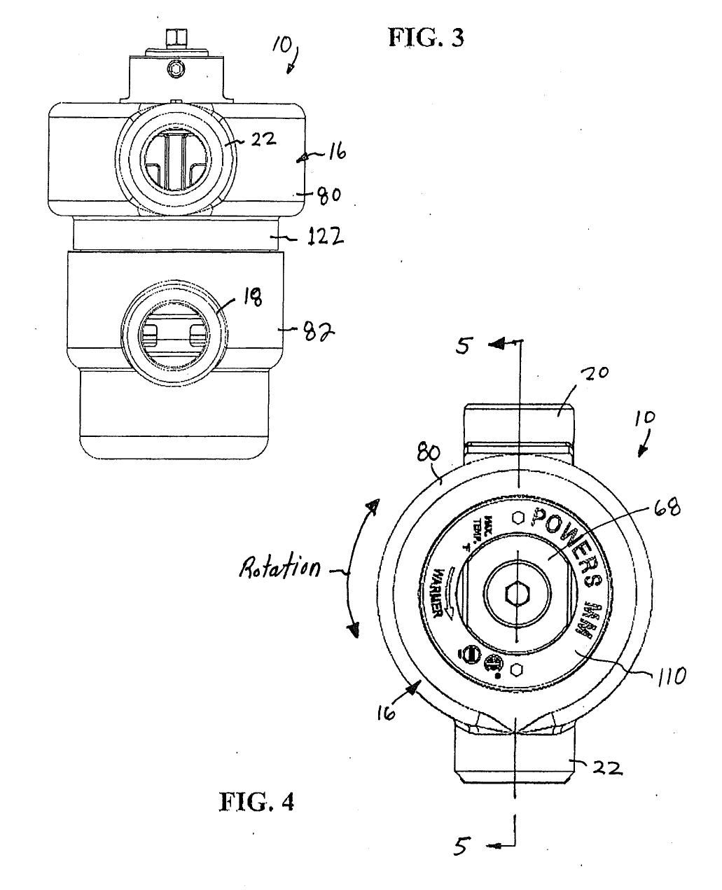

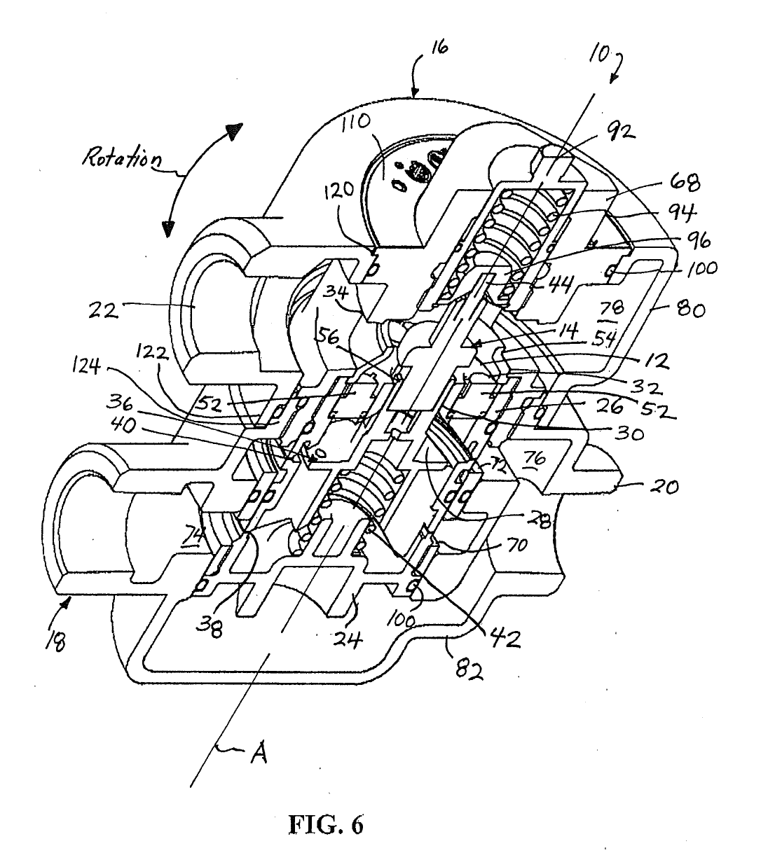

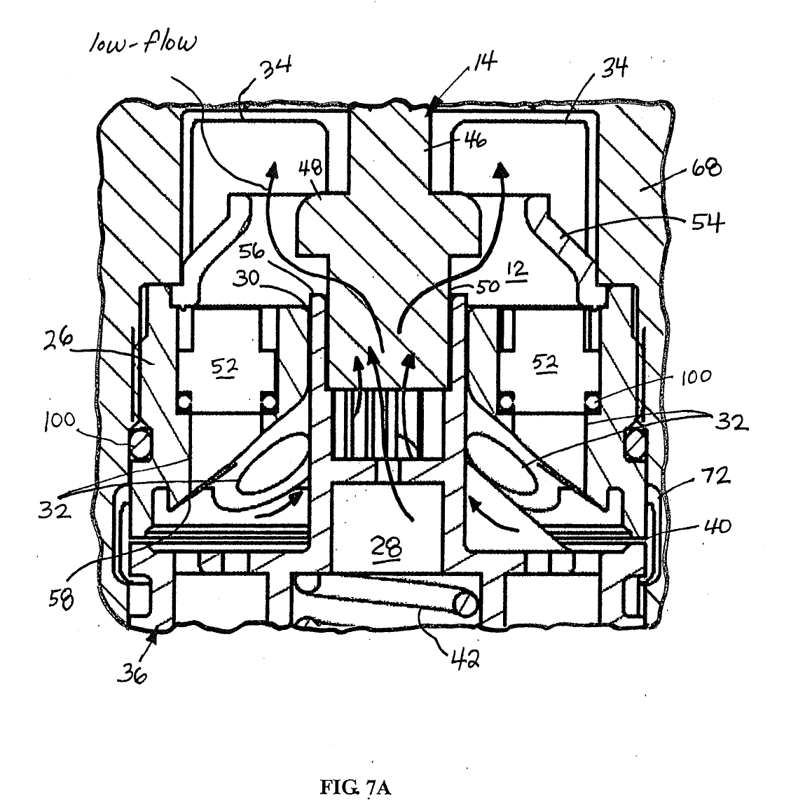

Referring to FIGS. 1-6, the first inlet 18 of the TMV 10 is for receiving a first fluid and the second inlet 20 is for receiving a second fluid, and the outlet 22 is for discharging a mixture of the first and the second fluids. In the exemplary embodiment shown, the first inlet 18 is designed to receive hot water, the second inlet 20 is designed to receive cold water, and tempered water is discharged from the outlet 22.

First and second spaced-apart seats 24, 26 are received in the housing 16 and define a mixing chamber 28 between the first and the second inlets 18, 20. The second seat 26 separates the mixing chamber 28 from the sensing chamber 12 of the housing 16 and includes a low-flow passageway 30 and a high-flow passageway 32 connecting the mixing chamber 28 and the sensing chamber 12. The sensing chamber 12 is connected to the outlet 22 of the housing 16 via outlet ports 34.

The TMV 10 also includes a plunger 36 received in the mixing chamber 28 that is movably between the first and the second seats 24, 26. The plunger 36 and the first seat 24 define a first valve opening 38 that controls flow from the first inlet 18 to the mixing chamber 28, and the plunger 36 and the second seat 26 define a second valve opening 40 that controls flow from the second inlet 20 to the mixing chamber 28. A spring 42 biases the plunger 36 away from the first seat 24 to open the first valve opening 38 and close the second valve 40 opening (i.e., more hot water and less cold water).

The thermostat element, or thermal motor 14, is at least partially located within the sensing chamber 12 and extends to the plunger 36. The thermal motor 14 includes a temperature responsive (expandable) piston 44 that extends from a cylinder 46 connected by a flange 48 to a casing 50. In general, the casing 50 contains a thermally expandable wax material, which pushes against the piston 44 to increase the overall length of the thermal motor 14 as a temperature of the wax increases. Expansion of the thermal motor 14, therefore, causes movement of the plunger 36 against the spring 42 and towards the first seat 24, such that the first valve opening 38 is closed and the second valve opening 40 is opened (i.e., less hot water and more cold water). The thermal motor 14 controls the temperature of the mixed fluid.

The TMV 10 also includes a check valve 52 received in the high-flow passageway 32 of the second seat 26. The check valve 52 is adapted to open and allow additional flow from the mixing chamber 28 to the sensing chamber 12 upon fluid flow through the TMV 10 rising to at least a predetermined high flow rate. The check valve 52 opens in response to a predetermined increase in pressure drop between the mixing chamber 28 and the sensing chamber 12. At all times, however, the excess flow passing through the open check valve 52 is directed through the sensing chamber 12 containing the thermal motor 14 of the TMV 10. None of the mixed fluid is allowed to bypass the sensing chamber 12.

The check valve 52 can be of any type sensitive to pressure. The check valve 52 may be spring-loaded and open completely once a certain pressure has been reached, or can be a valve of a type that opens gradually in response to a rise in pressure. If more than one check valve 52 is used, it is also possible to configure the valves to be responsive to different pressure values such that they react in sequence to changes in pressure. Thus as the pressure increases, more valves open, and as the pressure decreases the valves close again. The check valve(s) may be of any configuration or number to allow the desired fluid pressure dependent bypass of fluid necessary to allow the proper functioning of the TMV 10.

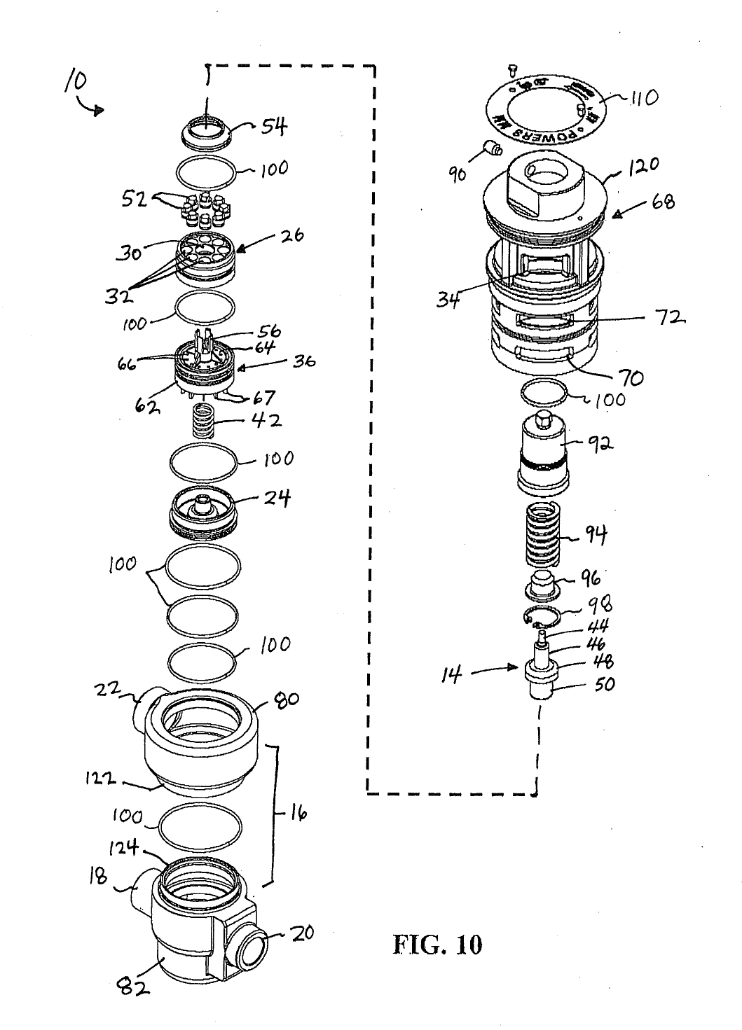

In the exemplary embodiment shown, the low-flow passageway 30 is centrally located in the second seat 26, and the second seat 26 includes a plurality of the high-flow passageways 32 arrayed around the low-flow passageway 30. Each high-flow passageway 32 contains one of the check valves 52. The arrayed high-flow passageways 32 of the second seat 26 are shown best in FIG. 10 of the drawings. Each of the check valves comprises a spring-loaded check valve 52 that opens completely once the predetermined high rate of flow has been reached, and then closes completely once the flow drops.

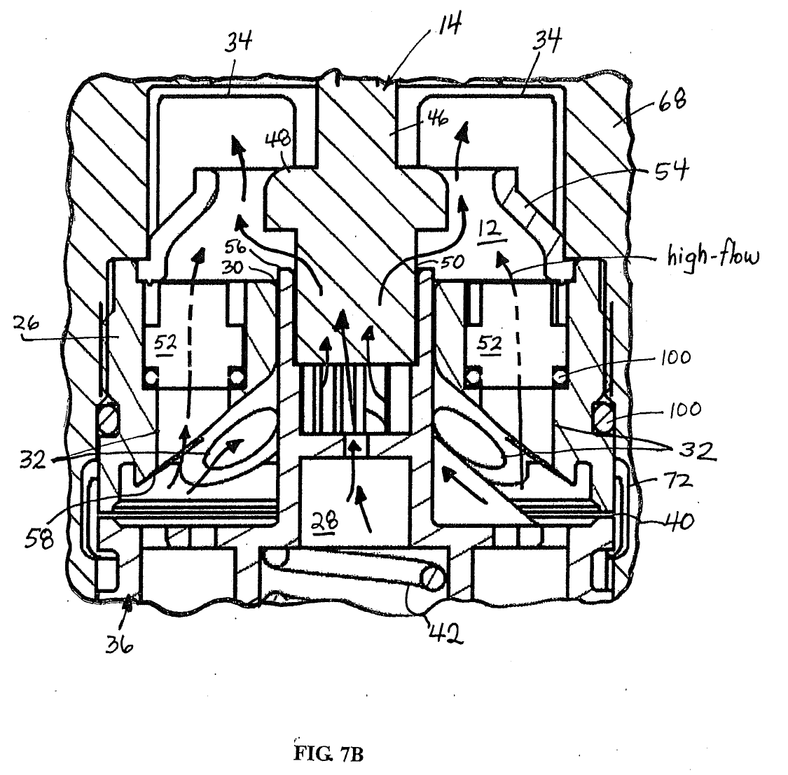

FIG. 7A illustrates low-flow conditions within the TMV 10, while FIG. 7B illustrates high-flow conditions. As shown, during low-flow conditions fluid is only allowed to pass through the low-flow passageway 30 of the second seat 26, while during high-flow conditions fluid is also allowed to flow through the high-flow passageways 32. As shown in FIGS. 7A and 7B, the TMV 10 also includes a flow-directing element 54 extending from the second seat 26 that directs fluid flow from the high-flow passageways 32 towards the thermal motor 14. In one exemplary embodiment the flow-directing element 54 is rigid. Alternatively, the flow-directing element 54 can be flexible.

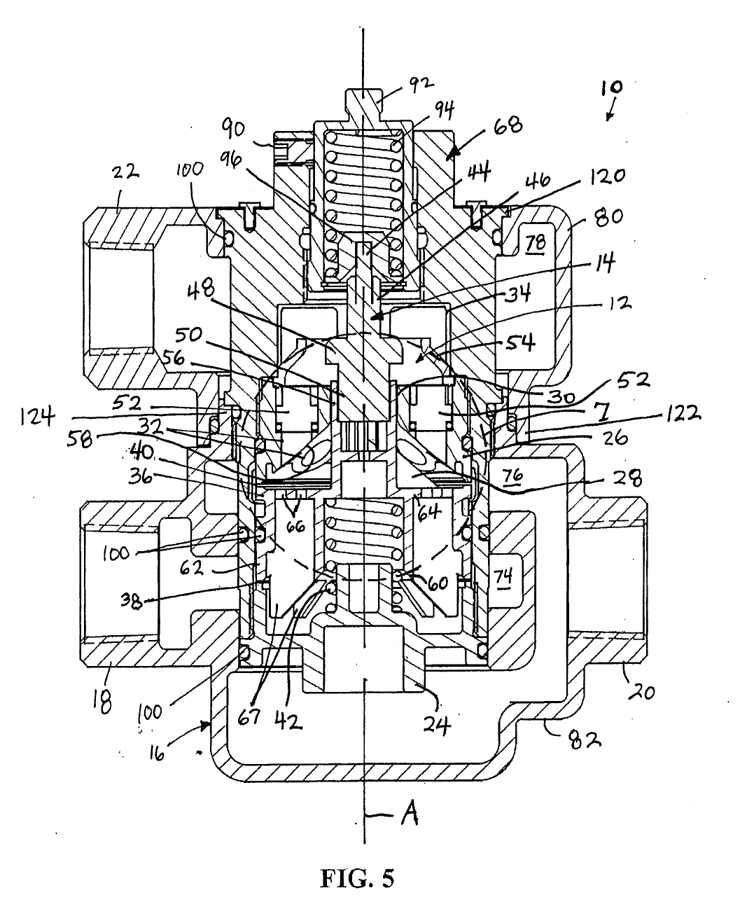

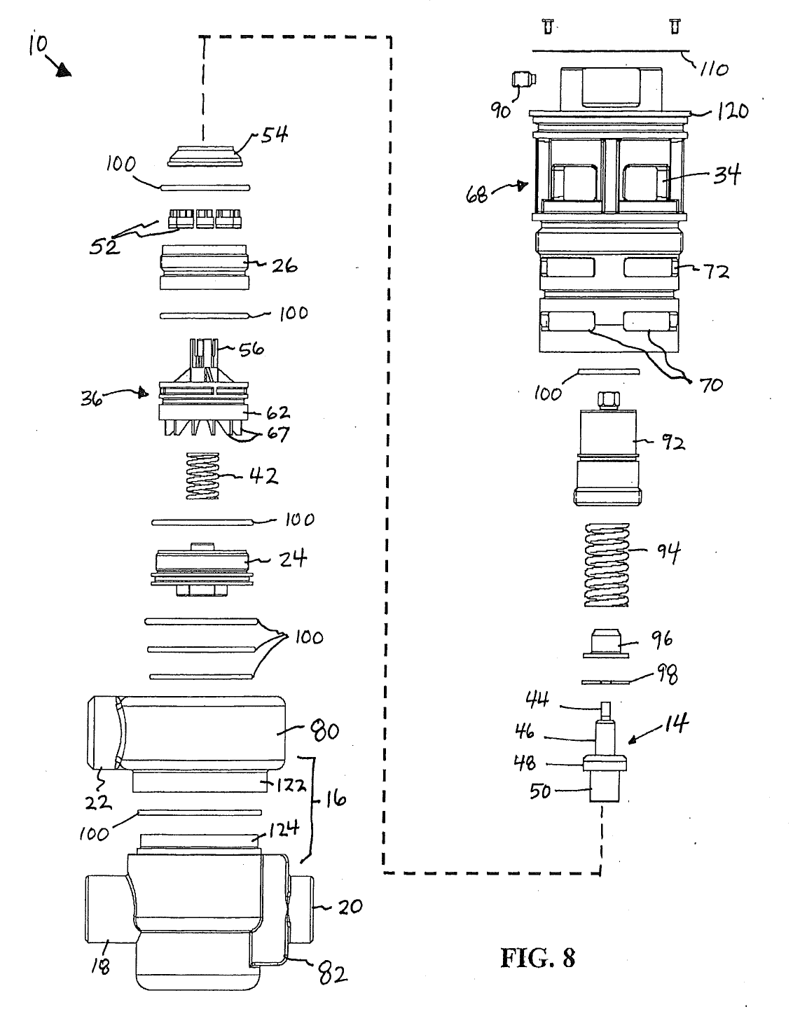

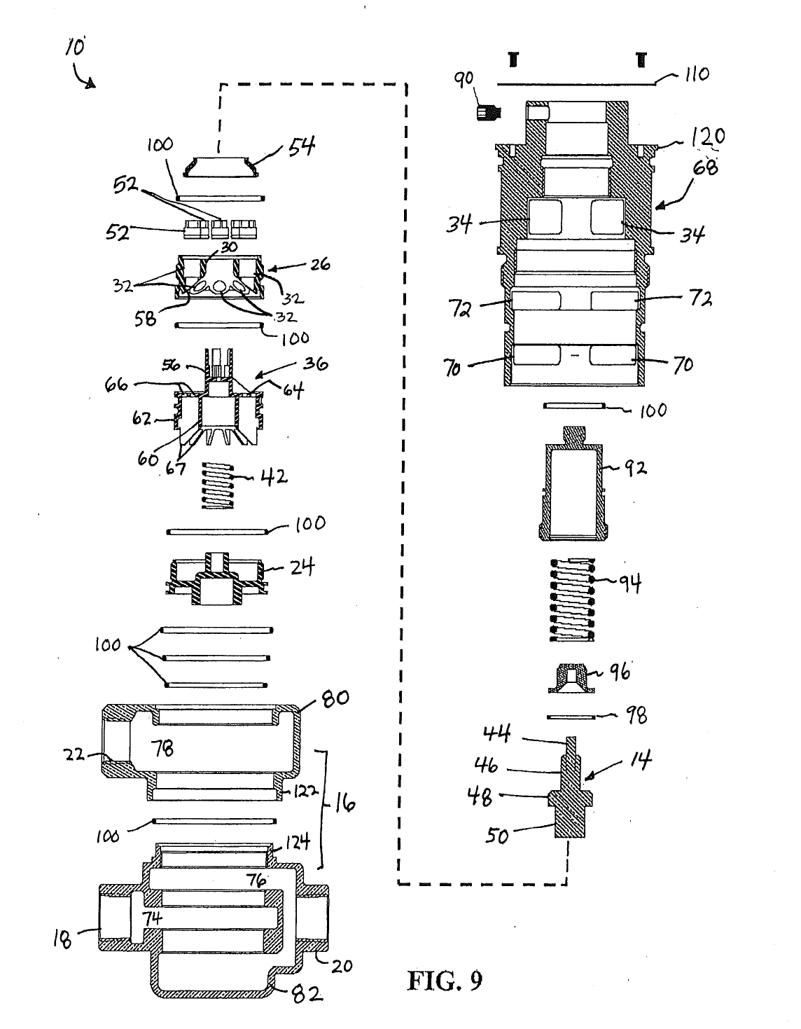

In the exemplary embodiment shown, the plunger 36 includes a socket 56 extending through the low-flow passageway 30 of the second seat 26. The socket 56 has openings for allowing flow through the low-flow passageway 30, and the thermal motor 14 is received in the socket 56. The casing 50 of the thermal motor 14 is partially received in the socket 56 of the plunger 36, and at least a portion of the casing 50 of the thermal motor 14 is received in the sensing chamber 12. The socket 56 is shown in FIGS. 5-10 of the drawings.

In the exemplary embodiment shown, the second seat 26 includes a funnel 58 on an underside thereof for directing fluid from the mixing chamber 28 to the low-flow passageway 30. The plunger 36 includes coaxial inner and outer tubes 60, 62 connected by a lateral wall 64. Fins 67 are provided between the inner and outer tubes 60, 62, and the lateral wall 64 includes apertures 66 for allowing the mixture of fluid flow from the first and the second valve openings 38, 40. A bottom edge of the outer tube 62 forms the first valve opening 38 in combination with the first seat 24, and a top edge of the outer tube 62 foams the second valve opening 40 in combination with the second seat 26.

According to another aspect of the present disclosure, the TMV 10 further includes the cartridge 68 received within the housing 16. The cartridge 68 is shown in FIGS. 5, 6, and 8-10 of the drawings. The first and the second seats 24, 26, the plunger 36, and the thermal motor 14 are coaxially mounted within the cartridge 68, which is generally cylindrical, and the mixing chamber 28 and the sensing chamber 12 are contained within and partially defined by the cartridge 68.

The cartridge 68 defines the outlet ports 34 connecting the sensing chamber 12 to the outlets 22 of the housing 16, and further defines first inlet ports 70 connecting the first valve opening 38 to the first inlet 18 of the housing 16 and second inlet ports 72 connecting the second valve opening 40 to the second inlet 20 of the housing 16. Screw threads secure the cartridge 68 within the housing 16, and secure the first and the second seats 24, 26 within the cartridge 68. The cartridge 68 allows easier assembly and disassembly of the TMV 10. In addition, the cartridge 68 prevents the movable plunger 36 from contacting the housing 16, and allows the more expensive housing 16 to last longer while the less expensive plunger 36 and valve seats 24, 26 are easily disassembled and replaced when worn.

It should be understood, however, that a TMV including a cartridge and a TMV including high-flow passageways and check valves are separate and independent inventions, which may be combined in a single TMV as shown in the exemplary embodiment of the drawings. Alternatively, a TMV constructed in accordance with the present disclosure can include the high-flow passageways and the check valves, but not include the cartridge.

In the exemplary embodiment shown, the housing 16 further comprises an annular first inlet chamber 74 connected to the first inlet 18 and surrounding the first inlet ports 70 of the cartridge 68, an annular second inlet chamber 76 connected to the second inlet 20 and surrounding the second inlet ports 72 of the cartridge 68, and an annular outlet chamber 78 connected to the outlet 22 and surrounding the outlet ports 34 of the cartridge 68. These chambers are shown in FIGS. 5, 6, and 9 of the drawings.

According to one aspect of the present disclosure, the housing 16 includes the upper portion 80 secured to the lower portion 82 by the cartridge 68. As illustrated by rotation arrows in FIGS. 1, 4, and 6, the TMV 10 is adapted such that the upper portion 80 of the housing 16 can be rotated with respect to the lower portion 82. This rotation feature is very helpful during installation of the TMV 10 and allows the outlet 18 to be oriented between 0° and 360° with respect to the first inlet 18 or the second inlet 20. In the exemplary embodiment shown, the first inlet 18, the second inlet 20, and the outlet 18 all extend radially outwardly from a central axis A of the TMV 10.

In the exemplary embodiment shown, the cartridge 68 is secured to the lower portion 82 by the screw threads, and in-turn includes a lip 120 that holds the upper portion 80 against the lower portion 82. The upper portion 80 includes a female extension 122 that is received over a male extension 124 of the lower portion 82. The lip 120 of the cartridge 68, the female extension 122 of the upper portion 80, and the male extension 124 of the lower portion 82 are provided with smooth surfaces such that the upper portion 80 can be rotated on the lower portion 82 and the cartridge 68. In an alternative embodiment, the upper portion 80 can be provided with a male extension and the lower portion 82 can be provided with a female extension.

The TMV 10 also includes an adjustable motor positioning assembly including a setscrew 90, a case 92, a spring 94, a cap 96, and a retainer ring 98. The TMV 10 further includes numerous o-rings 100 providing fluid-tight seals between the assembled parts of the TMV. In the exemplary embodiment shown, a label 110 is secured to an exposed top of the cartridge 68 with screws or by other means.

The present disclosure, therefore, provides a new and improved thermostatic (master) mixing valve. It should be understood, however, that the exemplary embodiment described in this specification has been presented by way of illustration rather than limitation, and various modifications, combinations and substitutions may be effected by those skilled in the art without departure either in spirit or scope from this disclosure in its broader aspects and as set forth in the appended claims. Accordingly, other embodiments are within the scope of the following claims. In addition, the mixing valve disclosed herein, and all elements thereof, are contained within the scope of at least one of the following claims. No elements of the presently disclosed thermostatic mixing valve are meant to be disclaimed.

What is claimed is:

1. A thermostatic mixing valve comprising:
a housing having first and second inlets and an outlet;
first and second spaced-apart seats received in the housing and defining a mixing chamber, wherein the second seat separates the mixing chamber from a sensing chamber and includes a low-flow passageway and a high-flow passageway connecting the mixing chamber and the sensing chamber, the sensing chamber is connected to the outlet of the housing through connecting outlet ports;
a plunger movably received between the first and the second seats, and the plunger and the first seat define a first valve opening controlling flow from the first inlet to the mixing chamber and the plunger and the second seat define a second valve opening controlling flow from the second inlet to the mixing chamber;
a thermal motor located at least partially within the sensing chamber and extending to the plunger, whereby expansion of the thermal motor causes movement of the plunger towards the first seat; and
a check valve received in the high-flow passageway of the second seat, the check valve adapted to open and allow additional flow from the mixing chamber to the sensing chamber upon fluid flow through the valve rising to at least a predetermined high rate of flow.

2. A valve according to claim 1, wherein the low-flow passageway is centrally located in the second seat and the second seat includes a plurality of the high-flow passageways arrayed around the low-flow passageway, and each of the high-flow passageways contains one of the check valves.

3. A valve according to claim 1, wherein the check valve comprises a spring-loaded check valve that opens completely once the predetermined high rate of flow has been reached.

4. A valve according to claim 1, further comprising a flow-directing element extending from the second seat that directs fluid flow from the high-flow passageway to the thermal motor.

5. A valve according to claim 1, wherein the plunger includes a socket extending through the low-flow passageway of the second seat, the socket having openings for allowing flow through the low-flow passageway, and the thermal motor is received in the socket.

6. A valve according to claim 5, wherein a casing of the thermal motor is partially received in the socket of the plunger.

7. A valve according to claim 1, wherein the low-flow passageway is centrally located in the second seat and the second seat includes a funnel for directing fluid from the mixing chamber to the low-flow passageway.

8. A valve according to claim 1, further comprising a cylindrical cartridge received within the housing, wherein the first and the second seats, the plunger, and the thermal motor are coaxially mounted within the cartridge, and the mixing chamber and the sensing chamber are contained within and partially defined by the cartridge, and wherein the cartridge defines the outlet ports connecting the sensing chamber to the outlets of the housing, and further defines first inlet ports connecting the first valve opening to the first inlet of the housing and second inlet ports connecting the second valve opening to the second inlet of the housing.

9. A valve according to claim 9, wherein the housing further comprises an annular first inlet chamber connected to the first inlet and surrounding the first inlet ports of the cartridge, an annular second inlet chamber connected to the second inlet and surrounding the second inlet ports of the cartridge, and an annular outlet chamber connected to the outlet and surrounding the outlet ports of the cartridge.

10. A valve according to claim 9, wherein screw threads secure the cartridge to the housing and secure the first and the second seats within the cartridge.

11. A valve according to claim 1, wherein the housing includes an upper portion defining the outlet secured to a lower portion defining the first and the second inlets, and the upper portion can be rotated about an axis of the housing with respect to the lower portion.

12. A thermostatic mixing valve comprising:
a housing having an upper portion defining an outlet and a lower portion defining first and second inlets;
a cartridge received in the housing and including first inlet ports connected to the first inlet of the housing, second inlet ports connected to the second inlet of the housing, and outlet ports connected to the outlet of the housing, wherein the cartridge is secured to the lower portion and holds the upper portion such that the upper portion can be rotated with respect to the lower portion and the cartridge about an axis of the housing;
first and second spaced-apart seats received in the cartridge, wherein a mixing chamber is defined by the cartridge between the first and second seats, and the second seat separates the mixing chamber from a sensing chamber defined by the second seat and the cartridge, and wherein passageways connect the mixing chamber to the sensing chamber;
a plunger slidably received in the cartridge between the first and the second seats, wherein the plunger and the first seat define a first valve opening controlling flow from the first inlet port to the mixing chamber and the plunger and the second seat define a second valve opening controlling flow from the second inlet port to the mixing chamber; and
a thermal motor located at least partially within the sensing chamber and extending between an end of the cartridge and the plunger, whereby expansion of the thermal motor causes movement of the plunger towards the first seat.

13. A valve according to claim 12, wherein the passageways connecting the mixing chamber and the sensing chamber comprise a low-flow passageway and a high-flow passageway, and a check valve is received in the high-flow passageway.

14. A valve according to claim 13, wherein the low-flow passageway is centrally located in the second seat and the second seat includes a plurality of the high-flow passageways arrayed around the low-flow passageway, and each of the high-flow passageways contains one of the check valves.

15. A valve according to claim 12, further comprising a flow-directing element extending from the second seat in the sensing chamber,

16. A valve according to claim 12, wherein the cartridge is secured to the lower portion of the housing with screw threads.

17. A valve according to claim 12, wherein the cartridge includes a lip holding the upper portion of the housing against the lower portion of the housing.

18. A valve according to claim 12, wherein the upper portion of the housing includes a female extension received over a male extension of the lower portion.

19. A valve according to claim 12, wherein the first and the second inlets of the lower portion of the housing extend radially outwardly from the axis of the housing.

20. A valve according to claim 12, wherein the outlet of the upper portion of the housing extends radially outwardly from the axis of the housing.
